(19) United States
(12) Patent Application Publication
(10) Pub. No.: US 2006/0073372 A1
(43) Pub. Date: Apr. 6, 2006

(54) Fuel cell system and stack used thereto

(76) Inventor: Dong-Myung Suh, Suwon-si (KR)

Correspondence Address: CHRISTIE, PARKER & HALE, LLP, PO BOX 7068, PASADENA, CA, 91109-7068, US

(21) Appl. No.: 11/239,756

(22) Filed: Sep. 29, 2005

(30) Foreign Application Priority Data
Oct. 4, 2004 (KR) 10-2004-0078644

(51) Int. Cl. H01M 8/00; H01M 2/08

(52) U.S. Cl. 429/35; 429/36; 429/12

(57) ABSTRACT

A stack for a fuel cell system including at least one electricity generating unit having a membrane electrode assembly and separators respectively disposed on both surfaces of the membrane electrode assembly, wherein gaskets are interposed on edges between the membrane electrode assembly and both of the separators, and wherein sealing members are disposed between the respective gaskets and the respective separators to maintain a seal between the membrane electrode assembly and the separators.

### CROSS-REFERENCE TO RELATED APPLICATION

This application claims priority to and the benefit of Korean Patent Application No. 10-2004-0078644, filed on Oct. 4, 2004, in the Korean Intellectual Property Office, the entire content of which is incorporated herein by reference.

### BACKGROUND OF THE INVENTION

1. Field of the Invention

The present invention relates to a fuel cell system, and more particularly, to a fuel cell system having an improved sealing structure between a membrane electrode assembly and a separator.

2. Description of the Related Art

As is well known, a fuel cell is an electricity generating system for directly generating electric energy through an electrochemical reaction between hydrogen contained in a hydrocarbon material such as methanol and oxygen (or air containing oxygen).

The fuel cell may use hydrogen generated by reforming a fuel such as methanol or ethanol. Because of this, the fuel cell can be applied to a wide range of applications including mobile power sources for vehicles, distributed power sources for homes or other buildings, and small-size power sources for electronic apparatuses.

The fuel cell is constructed with a stack formed by stacking a plurality of unit cells adjacent to one another. Each of the plurality of unit cells includes a membrane electrode assembly (MEA) for generating electricity through oxidation and reduction reactions of hydrogen and oxygen and two separators (also referred to as a bipolar plate), one attached on each side of the membrane electrode assembly to supply the hydrogen and the oxygen to the membrane electrode assembly.

In the fuel cell, gaskets are disposed on edges between the membrane electrode assembly and the two separators to maintain sealing between the membrane electrode assembly and the two separators.

During a process of assembling the stack, the gaskets are attached to the membrane electrode assembly by the two separators so as to block the hydrogen and the oxygen supplied to the membrane electrode assembly through the two separators from leaking out or prematurely mixing with each other.

However, when the stack is formed in a conventional fuel cell, a pressing force applied to a separator is not uniformly distributed to a corresponding gasket, and, thus, a gap frequently occurs between the corresponding gasket and the separator.

Therefore, in the conventional fuel cell, the gap causes impairment of the sealing between the membrane electrode assembly and the two separators, so that the hydrogen and the oxygen may leak out when the hydrogen and the oxygen pass through the separators.

Accordingly, in the conventional fuel cell, performance of the fuel cell may deteriorate due to decrease in pressure of the hydrogen and the oxygen passing through the separators because a normal electricity output of the stack cannot be obtained. In addition, the leakage of the hydrogen and the oxygen may cause an uncontrolled exothermic reaction resulting in an catastrophic accident.

### SUMMARY OF THE INVENTION

An embodiment of the present invention provides a stack for a fuel cell system having an improved sealing structure between a membrane electrode assembly and a separator to prevent occurrence of a gap between a gasket and the separator caused by a difference between pressing forces applied to separator.

In addition, the present invention also provides a fuel cell system having a fuel cell that includes the improved sealing structure.

According to an embodiment of the present invention, there is provided a stack for a fuel cell system, the stack including at least one electricity generating unit having a membrane electrode assembly and a separator disposed on a surface of the membrane electrode assembly. Gaskets are interposed on edges between the membrane electrode assembly and the separator, and a sealing member is disposed between the gasket and the separator to maintain a seal between the membrane electrode assembly and the separator.

In the aforementioned embodiment of the present invention, the separator may have a first region corresponding to the membrane electrode assembly and a second region corresponding to the gasket, and the sealing member may be disposed between an attaching portion of the gasket and the second region.

In addition, the sealing member may have a sealing layer coated on the attaching surface of the gasket corresponding to the second region.

In addition, the sealing member may have a sealing layer coated on the second region of the separator corresponding to the attaching surface of the gasket.

In addition, the sealing layer may be made of tar.

According to another embodiment of the present invention, there is provided a fuel cell system including the stack according to the aforementioned embodiment of the present invention, a fuel supply unit for supplying a fuel containing hydrogen to the stack, and an oxygen supply unit for supplying oxygen to the stack.

In the aforementioned embodiment of the present invention, the fuel supply unit may include a fuel tank for storing the fuel containing hydrogen and a fuel pump connected to the fuel tank.

In addition, the oxygen supply unit may include at least one air pump for pumping in air and for supplying air to the electricity generating unit.

In addition, the fuel supply unit may include a reformer connected to the electricity generating unit and the fuel tank to receive the fuel from the fuel tank, to generate a hydrogen-containing reforming gas from the fuel, and to supply the reforming gas to the stack.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a schematic block diagram showing an entire fuel cell system according to an embodiment of the present invention;

FIG. 2 is an exploded perspective view of a stack shown in FIG. 1;

FIG. 3 is an assembled cross-sectional view of an electricity generating unit shown in FIG. 2;

FIG. 4 is an exploded perspective view of a stack according to a modified embodiment of the present invention; and

FIG. 5 is an assembled cross-sectional view showing an electricity generating unit shown in FIG. 4.

### DETAILED DESCRIPTION

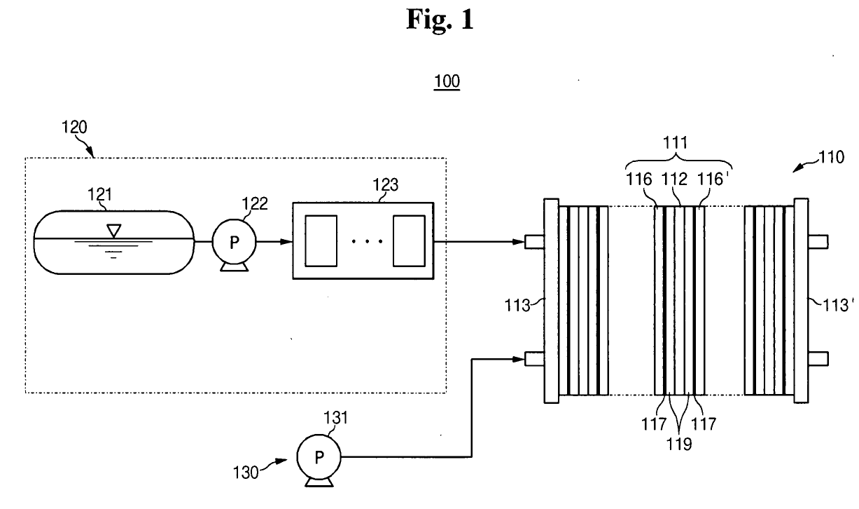

Referring to FIG. 1, a fuel cell system 100 utilizes a polymer electrolyte membrane fuel cell (PEMFC) scheme for generating hydrogen by reforming a fuel containing the hydrogen and for generating electricity energy through an electro-chemical reaction of the hydrogen with an oxidizing agent such as oxygen.

In the present invention, as a fuel, a liquid or gas fuel containing hydrogen, such as methanol, ethanol, or natural gas, may be employed. In the embodiment, the liquid fuel is exemplified.

In addition, the oxidizing agent reacting with the fuel may be pure oxygen stored in a separate storage unit or oxygen in the air. In the embodiment, the oxygen in the air is exemplified.

The fuel cell system 100 includes a stack 110 for generating electric energy through an electro-chemical reaction of the hydrogen and the oxygen, a fuel supply unit 120 for supplying the hydrogen to the stack 110, and an oxygen supply unit 130 for supplying the air to the stack 110.

The stack 110 includes electricity generating units (or unit cells) 111. Each of the electricity generating units 111 is constructed with a membrane electrode assembly (hereinafter referred to as MEA) 112 and two separators 116 and 116′ coupled to both sides of the MEA to generate electricity. An electricity generating unit 111 constitutes a unit cell of the fuel cell.

The fuel supply unit 120 includes a fuel tank 121 for storing the aforementioned fuel, a fuel pump 122 connected to the fuel tank 121, and a reformer 123 connected to the fuel tank 121 to generate a hydrogen-containing reforming gas from the fuel and to supply the reforming gas to at least one of the electricity generating units 111.

The oxygen supply unit 130 includes at least one air pump 131 for pumping in the air and supplying the pumped-in air to the at least one of the electricity generating units 111.

The reformer 123 of the fuel supply unit 120 has a structure for generating the reforming gas from the fuel through a chemical catalytic reaction using thermal energy and for reducing a concentration of carbon monoxide contained in the reforming gas.

For example, the reformer 123 may generates the reforming gas from the fuel through a catalytic reaction such as a steam reforming reaction, a partial oxidation reaction, and/or an auto-thermal reaction.

Further, the reformer 123 may reduce the concentration of the carbon monoxide contained in the reforming gas by using a catalytic reaction such as a water-gas shift (WGS) reaction and/or a preferential oxidation (PROX) reaction and/or by a hydrogen purification process using a separating membrane.

Alternatively, the fuel cell system 100 according to the present invention may utilize a direct oxidation fuel cell scheme capable of directly supplying the fuel to at least one of the electricity generating units 111 to generate electricity.

Unlike the aforementioned polymer electrolyte membrane fuel cell scheme, a fuel system employing the direct oxidation fuel cell scheme does not require the reformer 123 as shown in FIG. 1. Instead, the fuel supply unit 120 supplies the fuel stored in the fuel tank 121 directly to the stack 110 (or to at least one of the electricity generating units 111) through the fuel pump 122.

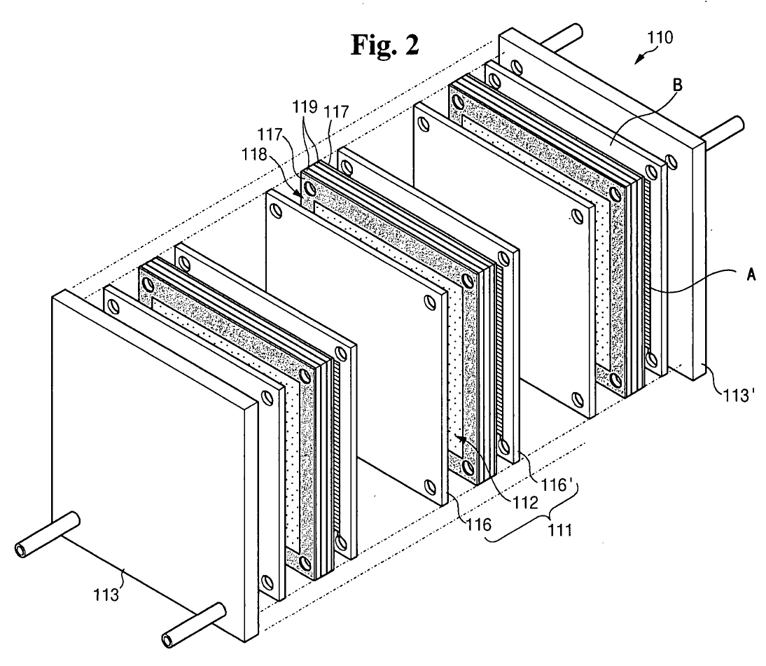

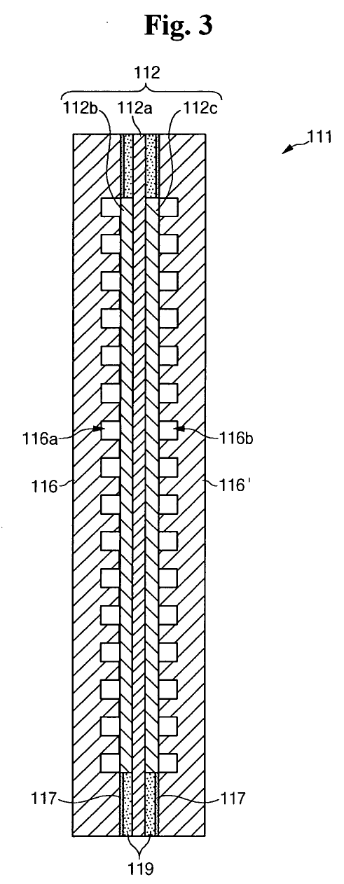

FIG. 2 is an exploded perspective view showing the stack 110 shown in FIG. 1, and FIG. 3 is a partial cross-sectional view showing one of the electricity generating units 111 shown in FIG. 2.

The stack 110 includes the plurality of the electricity generating units 111 stacked adjacent to one another as an integrated body.

In each of the electricity generating units 111, the MEA 112 interposed between the two separators 116 and 116′ is constructed with an electrolyte membrane 112a, an anode electrode 112b coupled to one side surface of the electrolyte membrane 112a, and a cathode electrode 112c coupled to the other (or another) side surface of the electrolyte membrane 112a.

The two separators 116 and 116′ interposed by the MEA 112 are respectively attached to be in close contact with the surfaces of both sides of the MEA 112 so that hydrogen channels 116a and air channels 116b are respectively coupled to both sides of the MEA 112.

The hydrogen channels 116a are disposed to a side of the anode electrode 112b of the MEA 112, and the air channels 116b are disposed to a side of the cathode electrode 112c of the MEA 112.

In addition to the function of supplying the hydrogen and the oxygen in the air to the MEA 112, the two separators 116 and 116′ have a function of serially connecting the anode electrode 112b with the cathode electrode 112c.

Each of the separators 116 and 116′ may be divided into a first region A, that is, one surface of the separator 116 or 116′, where the hydrogen channels 116a or the air channels 116b are formed, and a second region B, that is, an outer edge of the separator 116 or 116′ (see FIG. 2).

Pressing plates 113 and 113′ are coupled to the outmost portions of the stack 110 to press and engage the plurality of the electricity generating units 111 to be in close contact with each other. In addition, the hydrogen channels 116a and the oxygen channels 116b are disposed on (or included with) the pressing plates 113 and 113′, and, thus, the pressing plates 113 and 113′ may also have a function that is substantially the same as the aforementioned separators 116 and 116′.

Here, engagement bars (not shown) engaged with screws are used with the pressing plates 113 and 113′ to substantially press and engage the plurality of the electricity generating units 111 to be in close contact with the pressing plates 113 and 113′.

Alternatively, instead of using the pressing plates 113 and 113′, the aforementioned engagement bars may be provided with the separators 116 and 116′ of the outmost ones of the plurality of electricity generating units 111 to closely attach and engage the plurality of the electricity generating units 111 with each other.

In addition, gaskets 119 for sealing spaces between the MEA 112 and the two separators 116 and 116′ are coupled to respective edges between the MEA 112 and the two separators 116 and 116′.

Specifically, the gaskets 119 are coupled to the respective second regions B of the separators 116 to prevent the hydrogen and the air supplied to the MEA 112 through the hydrogen channel 116a and the air channel 116b of the separators 116 and 116′ from leaking out or mixing with each other.

The gaskets 119 may be made of an elastic material such as a rubber, for example, a silicon rubber, a fluoride rubber, and/or an olefin rubber.

During a process of assembling the stack 110, when the plurality of the electricity generating units 111 are pressed and attached by the pressing plates 113 and 113′ to be in close contact with each other, a force is exerted on the separators 116 and 116′, and then, the gaskets 119 are suitably contracted within an elastic range thereof to maintain a surface pressure required for gas sealing the spaces between the separators 116 and 116′ and the MEA 112, to prevent a gas leakage between the separators 116 and 116′ and the MEA 112 during the operation of the stack 110.

Furthermore, in a case where pressing forces of the separators 116 and 116′ exerted on the gaskets 119 are not uniformly distributed over the entire region of the gaskets 119 or in a case where there is a difference between the pressing forces of both of the separators 116 and 116′, a sealing member 118 is provided to seal gaps occurring between the separators 116 and 116′ and the MEA 112.

In the embodiment, the sealing member 118 has sealing layers 117 disposed between the second regions B of the separators 116 and 116′ and the MEA 112 to maintain a seal between the MEA 112 and the separators 116.

More specifically, a sealing layer 117 is coated with a predetermined thickness on a surface of a gasket 119 attached to the second region B of each of (or at least one of) the separators 116 and 116′. In the embodiment, the sealing layer 117 is coated on the surface of the gasket 119 by spraying a sealing material made of tar with a nozzle so as to be formed on the sealing layer 117 with a predetermined thickness on the surface of the gasket 119.

Alternatively, the sealing layer 117 may be constructed with vacuum grease.

In other words, the sealing layer 117 of the present invention is constructed with a material for maintaining a stable state at a high temperature in order not to deteriorate sealing performance.

In the fuel cell system 100 having the aforementioned construction, since the sealing layers 117 are disposed between the second regions B of the separators 116 and 116′ and the gaskets 119, when the separators 116 and 116′ interposed by the MEA 112 are pressed and attached with each other, the sealing layers 117 are attached on the second regions B of the separators 116 and 116′ and corresponding surfaces of the gaskets 119, so that it is possible to improve the sealing performance between the separators 116 and 116′ and the gasket 119.

Therefore, even in a case where the pressing force exerted on the separators 116 and 116′ is not uniform, the sealing layers 117 are still closely attached on the corresponding attaching surfaces of the gaskets 119 and the attaching surfaces of the separators 116 and 116′. As such, the effective pressing force exerted through the separators 116 and 116′ can be more uniformly distributed to the gasket 119 and the seal between the gasket 119 and the separators 116 and 116′, so that the sealing between the MEA 112 and the separators 116 and 116′ is improved.

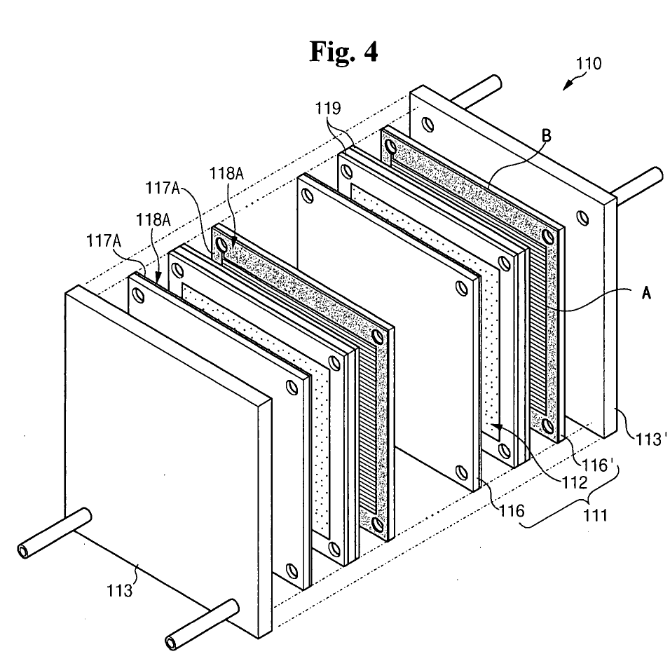

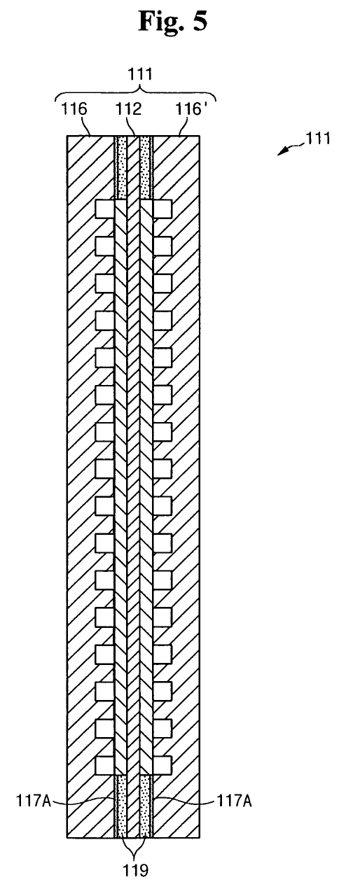

FIG. 4 is an exploded perspective view of a stack according to a modified embodiment of the present invention, and FIG. 5 is an assembled cross-sectional view showing a construction of an electricity generating unit shown in FIG. 4. In FIGS. 4 and 5, the same reference numerals as those of FIGS. 2 and 3 denote the same components having the same functions, and thus detailed description thereof is omitted.

Referring to FIGS. 4 and 5, unlike the aforementioned embodiment of FIGS. 2 and 3, a sealing layer 117A disposed between each of the separators 116 and 116′ and each of the gaskets 119 is not coated on the gaskets 119, and, instead, a sealing member 118A is constructed by coating the sealing layer 117A with a predetermined thickness on the second region B of each of the separators 116 and 116′.

In the modified embodiment, the other components and operations are the same as those of the aforementioned embodiment, and thus detailed description thereof is omitted.

In general, according to a fuel cell system of the present invention, since a sealing layer is disposed between a separator and a gasket to uniformly distribute a pressing force exerted through the separator over a surface of the gasket during the formation of a stack, a gap is not formed between the gasket and the separator, so that hydrogen or oxygen can be more effectively blocked from leaking out between the gasket and the separator during the operation of the stack.

Therefore, according to the fuel cell system of the present invention, electric power suitable to a unique performance condition of the stack can be obtained, and a decrease in pressure of hydrogen and oxygen supplied to an MEA can be prevented, so that it is possible to further improve performance of the fuel cell system.

In addition, the present invention can reduce occurrences of uncontrolled exothermic reactions due to leakage of hydrogen and oxygen that may result in a catastrophic accident.

While the invention has been described in connection with certain exemplary embodiments, it is to be understood by those skilled in the art that the invention is not limited to the disclosed embodiments, but, on the contrary, is intended to cover various modifications included within the spirit and scope of the appended claims and equivalents thereof.

What is claimed is:

1. A fuel cell system comprising:
a stack having an electricity generating unit for generating electric energy through an electro-chemical reaction of hydrogen and oxygen;
a fuel supply unit for supplying a fuel containing hydrogen to the stack; and
an oxygen supply unit for supplying oxygen to the stack,
wherein the electricity generating unit comprises a membrane electrode assembly and a separator attached to a side surface of the membrane electrode assembly,
wherein a gasket is interposed between edges of the membrane electrode assembly and the separator, and
wherein a sealing member is disposed between the gasket and the separator to maintain a seal between the membrane electrode assembly and the separator.

2. The fuel cell system of claim 1,
wherein the separator has a first region corresponding to the membrane electrode assembly and a second region corresponding to the gasket and at an outer edge of the first region, and
wherein the sealing member is disposed between the gasket and the second region.

3. The fuel cell system of claim 2, wherein the sealing member has a sealing layer coated on a surface of the gasket corresponding to the second region.

4. The fuel cell system of claim 2, wherein the sealing member has a sealing layer coated on the second region of the separator corresponding to a surface of the gasket.

5. The fuel cell system of claim 3, wherein the sealing layer is made of tar.

6. The fuel cell system of claim 4, wherein the sealing layer is made of tar.

7. The fuel cell system of claim 1, wherein the fuel supply unit comprises:
a fuel tank for storing the fuel containing hydrogen; and
a fuel pump connected to the fuel tank.

8. The fuel cell system of claim 1, wherein the oxygen supply unit comprises at least one air pump for pumping in air and for supplying air to the electricity generating unit.

9. The fuel cell system of claim 7, wherein the fuel supply unit comprises a reformer connected to the electricity generating unit and the fuel tank to receive the fuel from the fuel tank, to generate a hydrogen-containing reforming gas from the fuel, and to supply the reforming gas to the stack.

10. The fuel cell system of claim 1, wherein the fuel cell system is constructed by using a polymer electrolyte membrane fuel cell scheme.

11. The fuel cell system of claim 1, wherein the fuel cell system is constructed by using a direct oxidation fuel cell scheme.

12. A stack for a fuel cell system, the stack comprising:
at least one electricity generating unit having a membrane electrode assembly and a separator disposed on a surface of the membrane electrode assembly;
a gasket interposed on edges between the membrane electrode assembly and the separator; and
a sealing member disposed between the gasket and the separator to maintain a seal between the membrane electrode assembly and the separator.

13. The stack of claim 12,
wherein the separator has a first region corresponding to the membrane electrode assembly and a second region corresponding to the gasket, and
wherein the sealing member is disposed between an attaching portion of the gasket and the second region.

14. The stack of claim 13, wherein the sealing member has a sealing layer coated on the attaching surface of the gasket corresponding to the second region.

15. The stack of claim 13, wherein the sealing member has a sealing layer coated on the second region of the separator corresponding to the attaching surface of the gasket.

16. The stack of claim 14, wherein the sealing layer is made of tar.

17. The stack of claim 15, wherein the sealing layer is made of tar.

18. An electricity generating unit for a stack of a fuel cell system, the electricity generating unit comprising:
a membrane electrode assembly having a first surface and a second surface;
a first separator disposed on the first surface of the membrane electrode assembly;
a second separator disposed on the second surface of the membrane electrode assembly;
a first gasket interposed between the membrane electrode assembly and the first separator;
a second gasket interposed between the membrane electrode assembly and the second separator; and
a sealing member having a first sealing layer disposed between the first gasket and the first separator to maintain a seal between the membrane electrode assembly and the first separator and a second sealing layer disposed between the second gasket and the second separator to maintain a seal between the membrane electrode assembly and the second separator.

19. The electricity generating unit of claim 18, wherein the first sealing layer is coated on the first gasket to correspond to an attaching surface of the first separator.

20. The electricity generating unit of claim 18, wherein the first sealing layer is coated on the first separator to correspond to an attaching surface of the first gasket.

21. The electricity generating unit of claim 18, wherein the first sealing layer comprises a tar material coated on the first gasket or the first separator.
